(19) United States
(12) Patent Application Publication
(10) Pub. No.: US 2015/0048129 A1
(43) Pub. Date: Feb. 19, 2015

(54) MODULAR TRUCK BED STORAGE SYSTEM

(71) Applicant: Jeff A. Wilson, Lakewood, CO (US)

(72) Inventor: Jeff A. Wilson, Lakewood, CO (US)

(21) Appl. No.: 14/340,220

(22) Filed: Jul. 24, 2014

Related U.S. Application Data
(60) Provisional application No. 61/865,742, filed on Aug. 14, 2013.

(51) Int. Cl. B60R 9/06

(52) U.S. Cl. CPC B60R 9/065
USPC 224/404

(57) ABSTRACT

A modular truck bed storage system is disclosed which may be readily assembled and unassembled in a bed of a truck. An example of the truck bed storage system includes a removable end panel, and a lid assembly forming a compartment in the truck bed. The lid assembly has a top portion connected to a frame to operate between an open position and a closed position. The frame is configured for securement to at least one sidewall of a truck bed. Another example includes side panels and a floor plate. Another example includes multiple end panels and a sectioned lid, enabling sub-compartments within the compartment.

### PRIORITY CLAIM

This application claims the priority benefit of U.S. Provisional Patent Application No. 61/865,742 filed Aug. 14, 2013 for “Truck Storage” of Jeff A. Wilson, hereby incorporated by reference in its entirety as though fully set forth herein.

### BACKGROUND

Pickup trucks continue to be a popular choice of consumers for a variety of uses (e.g., personal/recreational and commercial transportation). One reason for their popularity is the truck bed which enables transport of cargo and other articles outside of the passenger cabin. Unfortunately, anything stowed in the truck bed generally remains visible and is susceptible to weather and theft.

### BRIEF DESCRIPTION OF THE DRAWINGS

FIG. 1 is a perspective view of an example assembled truck bed storage system, as the lid assembly may be in a closed position.

FIG. 2 illustrates the example assembled truck bed storage system shown in FIG. 1, as the lid assembly may be in an open position.

FIG. 3 shows an example end panel of the example truck bed storage system.

FIG. 4 illustrates installation of the example end panel shown in FIG. 3.

FIG. 5 is a perspective view of another example assembled truck bed storage system, as the lid assembly may be in a closed position.

FIG. 8 illustrates the example assembled truck bed storage system shown in FIG. 5, as the lid assembly may be in an open position.

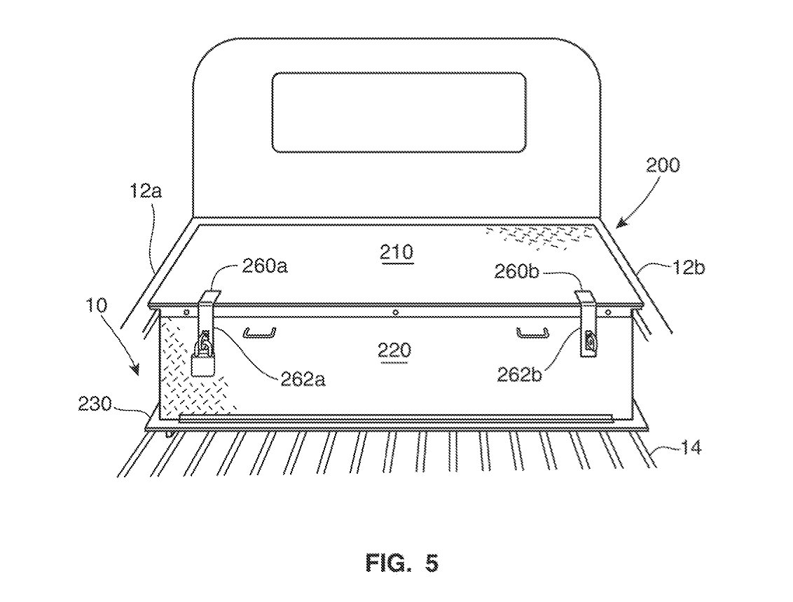

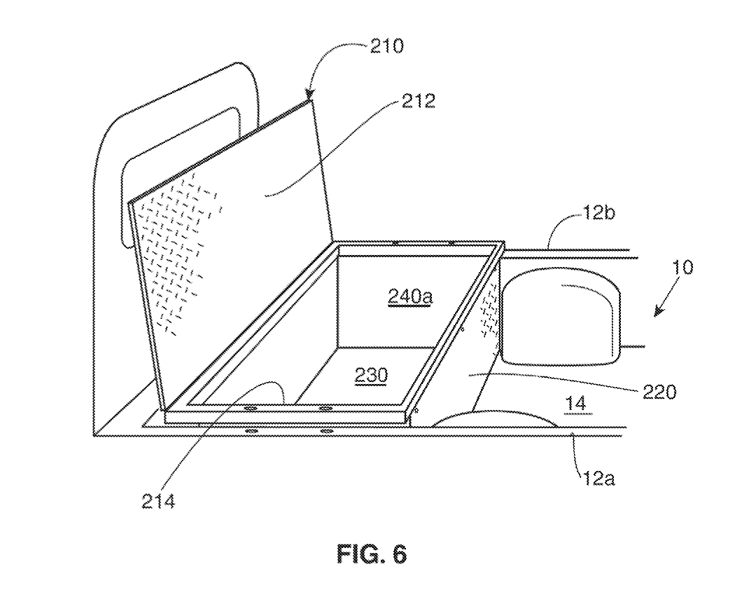

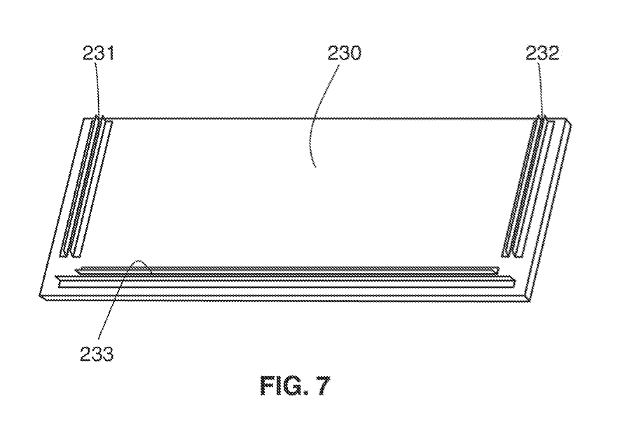

FIG. 7 illustrates a floor plate of the truck bed storage system shown in FIG. 5.

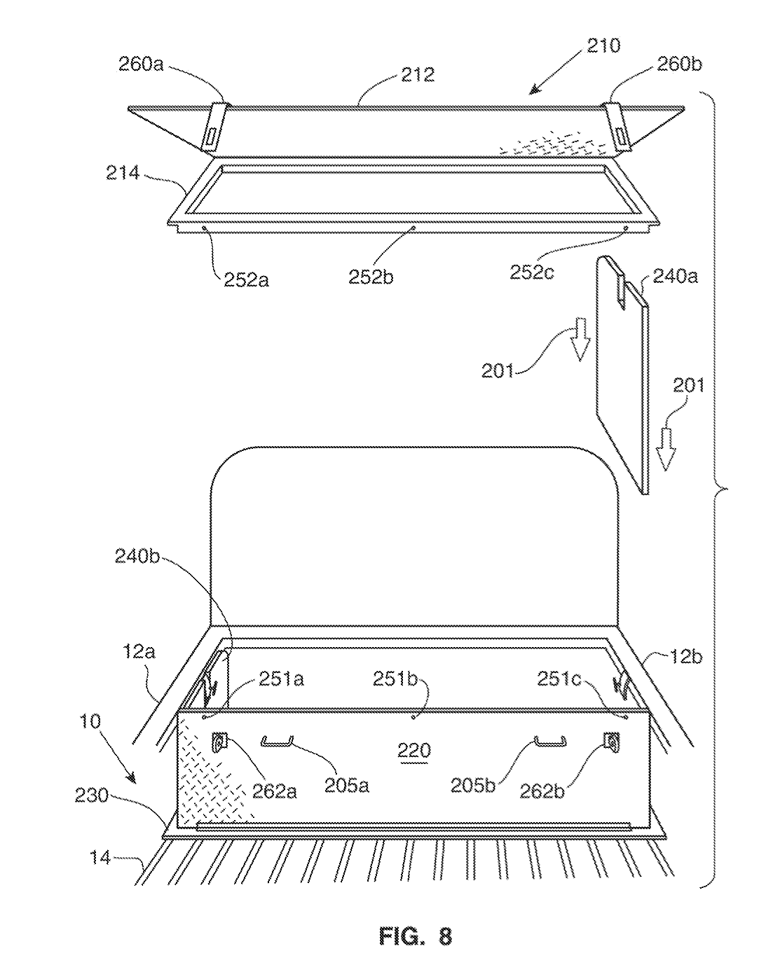

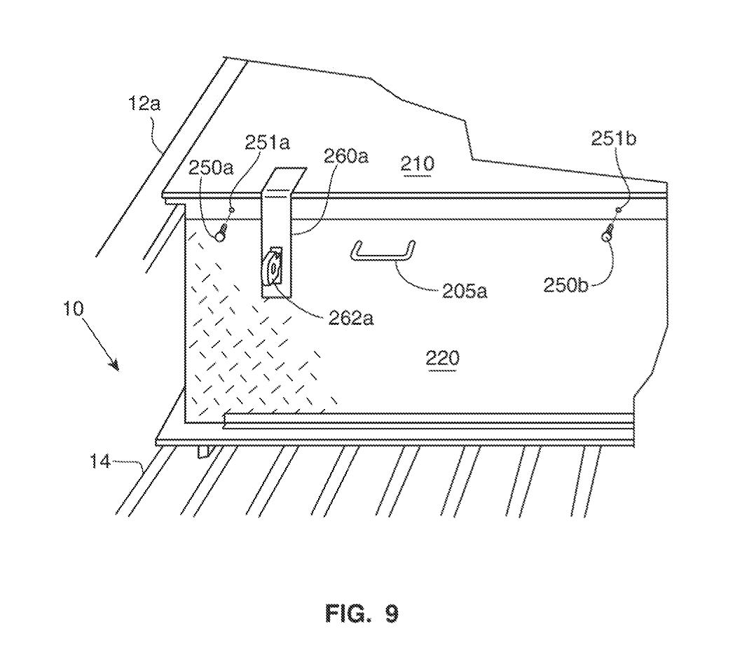

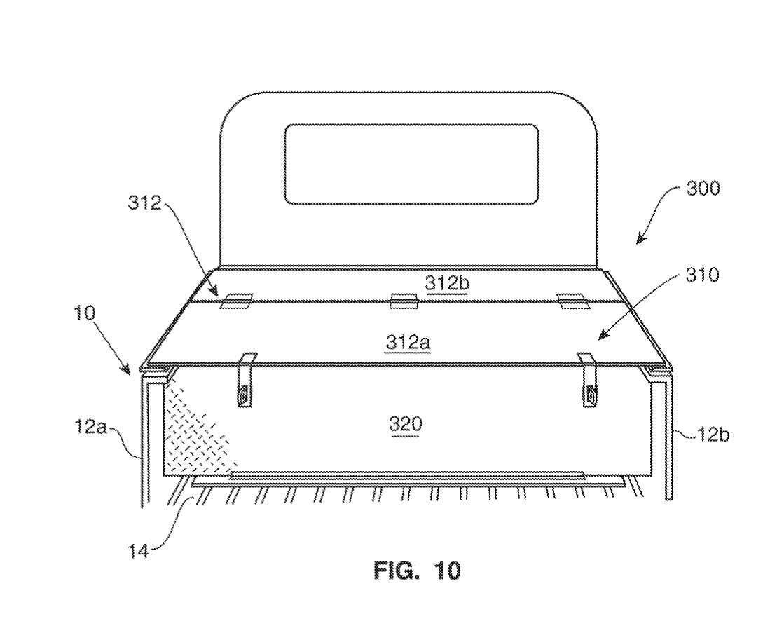

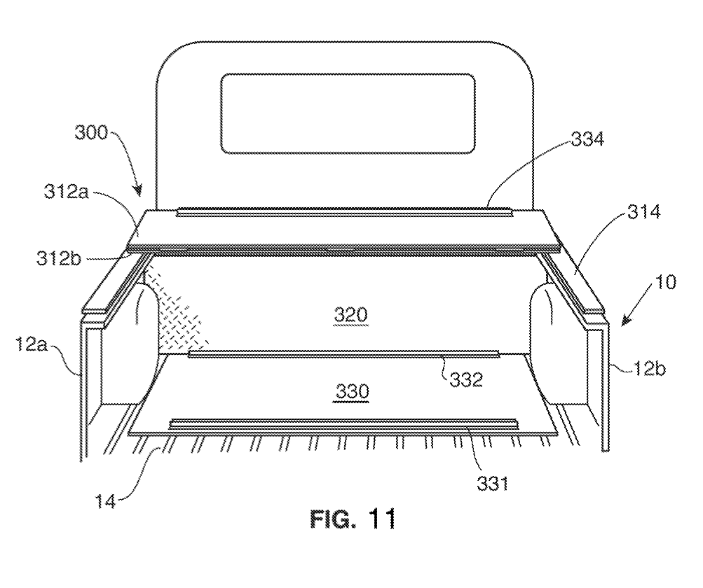

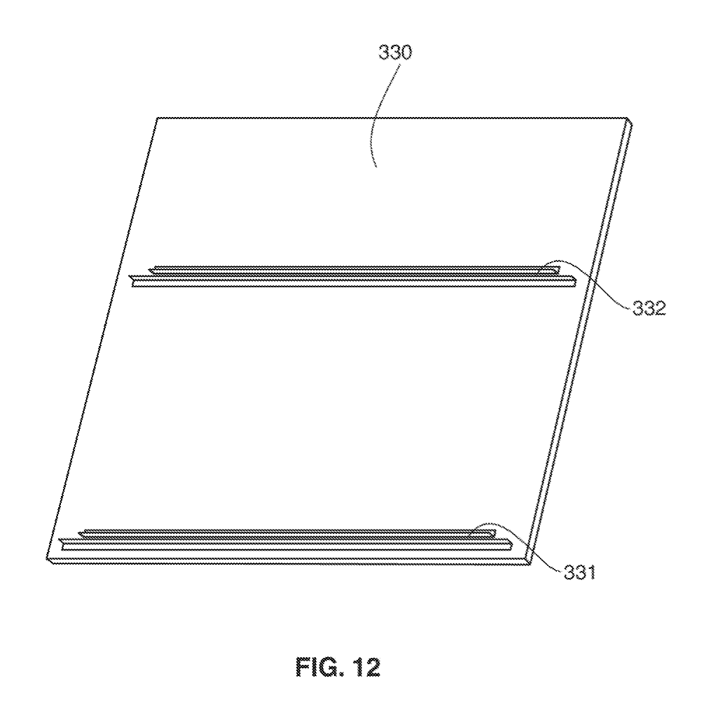

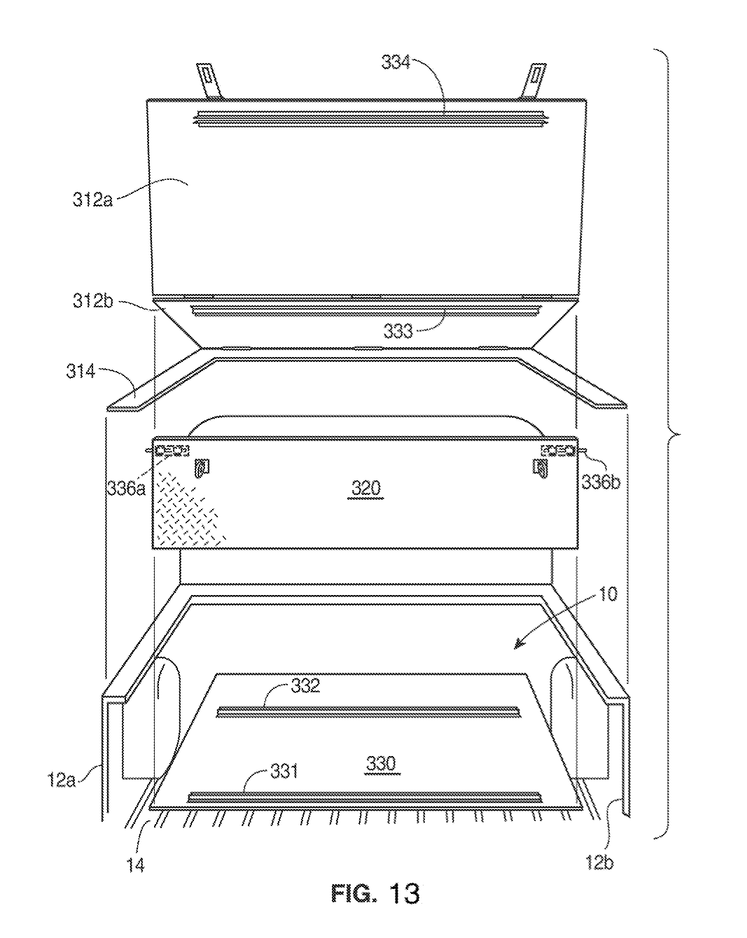

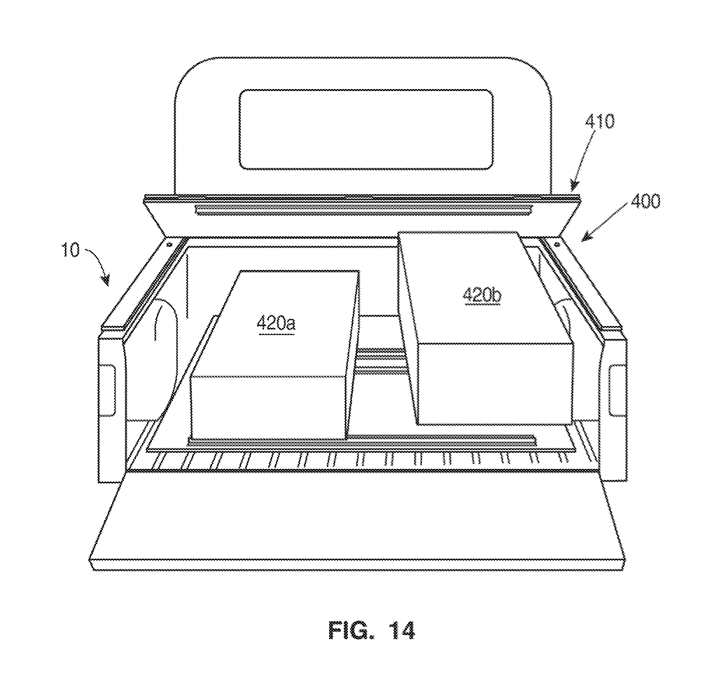

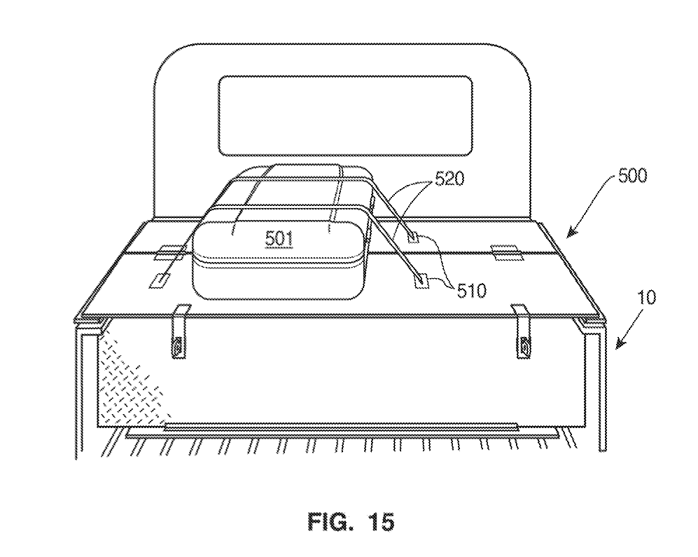

FIG. 8 illustrates installation of the example the truck bed storage system shown in FIG. 5.

FIG. 9 illustrates installation of a lid of the example the truck bed storage system shown in FIG. 5.

FIG. 10 is a perspective view of another example assembled truck bed storage system, as the lid assembly may be in a closed position.

FIG. 11 illustrates the example assembled truck bed storage system shown in FIG. 10, as the lid assembly may be in an open position.

FIG. 12 illustrates a floor plate of the truck bed storage system shown in FIG. 10.

FIG. 13 illustrates installation of the example the truck bed storage system shown in FIG. 10.

FIG. 14 illustrates the example truck bed storage system as it may be configured to haul an oversize load.

FIG. 15 illustrates the example truck bed storage system as it may be configured to haul a load on top of the lid.

### DETAILED DESCRIPTION

A modular truck bed storage system is disclosed which may be readily assembled and unassembled in a bed of a truck. An example of the truck bed storage system includes a removable end panel, and a lid assembly forming a compartment in the truck bed. The lid assembly has a top portion connected to a frame to operate between an open position and a closed position. The frame is configured for securement to at least one sidewall of a truck bed. Another example includes side panels and a floor plate. Another example includes multiple end panels and a sectioned lid, enabling sub-compartments within the compartment.

In an example, surfaces of the truck bed itself (e.g., sidewalls and floor) are used to form part of the storage compartment. In one example, only two sides of the truck-bed storage system are added to the truck bed to yield a six-sided storage compartment. In a second example, a floor plate may be added. In a third example, a foldable lid and multi-section storage compartment is provided.

In an example, a modular design enables a user to readily position separate components of the truck bed storage system into a truck bed. As such, the user does not have to ask for assistance and/or struggle by him or herself to position a heavy, cumbersome toolbox into the truck-bed. In addition, the truck bed storage system can be readily uninstalled from the truck bed, and easily stored (e.g., in a small storage closet). In examples, less material is needed to manufacture the truck bed storage system (e.g., than typical of pickup truck tool boxes).

Before continuing, it is noted that as used herein, the terms “includes” and “including” mean, but is not limited to, “includes” or “including” and “includes at least” or “including at least.” The term “based on” means “based on” and “based at least in part on.”

It should be further noted that the scope of the disclosure should not be limited to dimensions which may be represented in the figures. Various sizes and dimensions of the invention may be used to accommodate a variety of vehicles (e.g., large and smaller truck beds). In addition, components shown and described in the example(s) may be interchanged and/or added to and/or removed from components of another of the example(s).

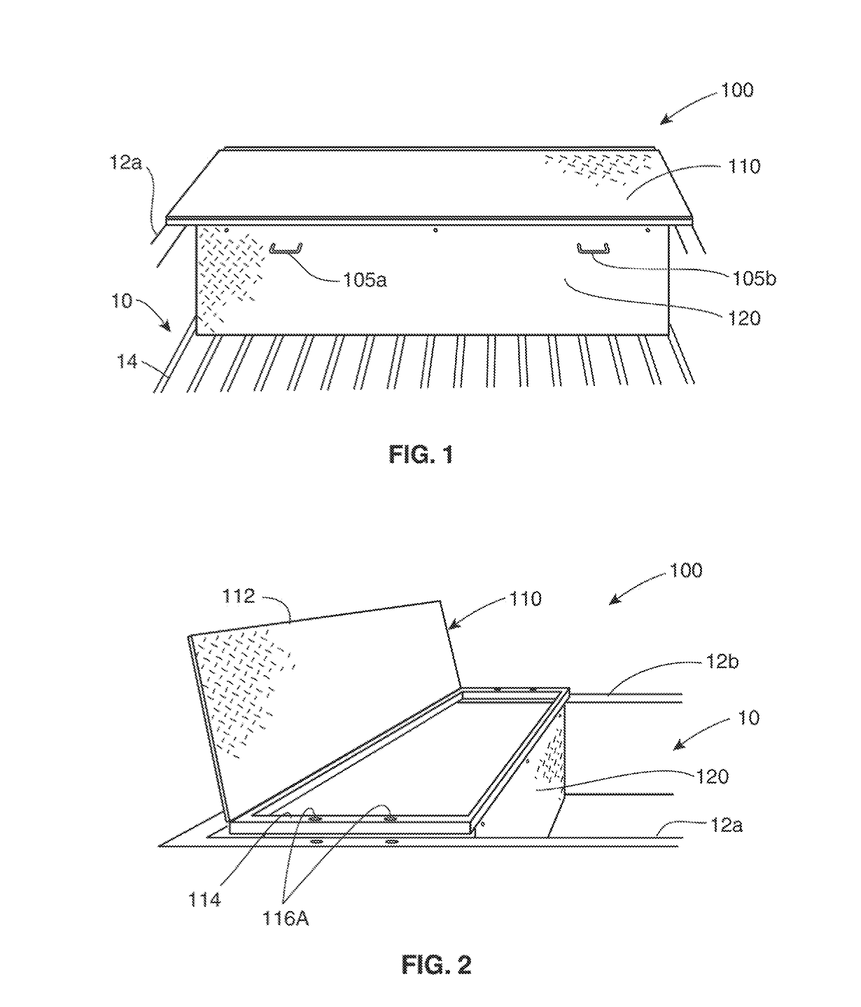

FIG. 1 is a perspective view of an example assembled truck bed storage system 100, as a lid assembly 110 may be in a closed position. FIG. 2 illustrates the example assembled truck bed storage system 100 shown in FIG. 1, as the lid assembly 110 may be in an open position, The example truck bed storage system 100 is shown in FIGS. 1 and 2 as it may be mounted in a truck bed 10 having sidewalls 12a-b and floor 14.

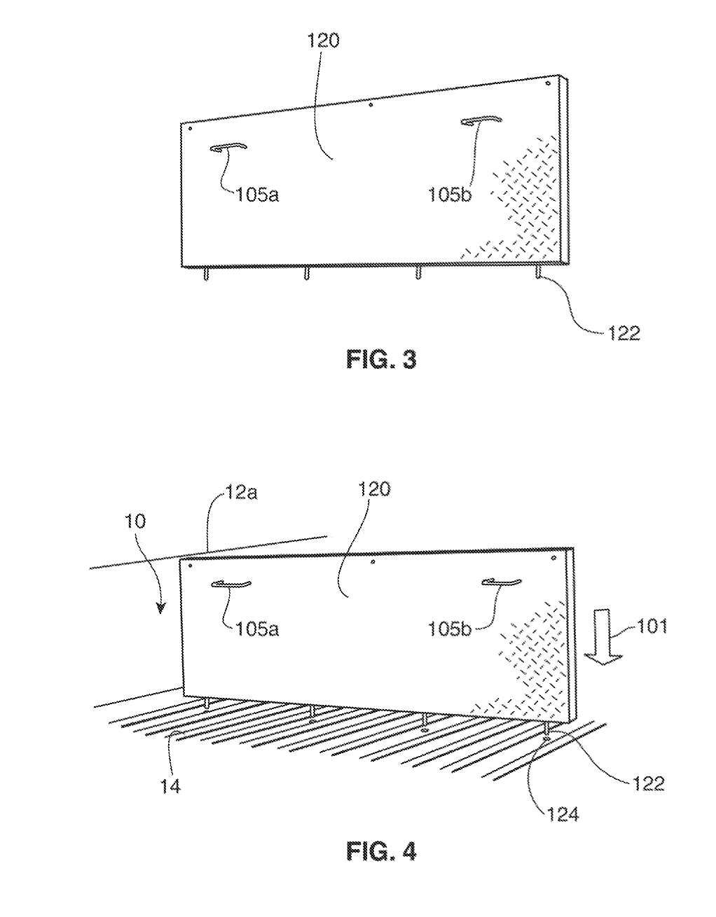

The lid assembly 110 may include top portion 112 and a frame 114. The top portion 112 may be hinged to the frame 114. The example truck bed storage system 100 also includes an end plate 120. FIG. 3 shows an example end panel 120 of the example truck bed storage system. The end panel 120 may be provided in the truck bed 10, e.g. by way of pins 122 attached to a bottom edge of the end plate 120.

The truck bed storage system 100 may be manufactured of any suitable material, such as but not limited to, metal, plastic, metal or plastic-coated wood, and/or other materials.

FIG. 4 illustrates installation of the example end panel shown in FIG. 3. The end plate can then be placed into the truck bed 10, e.g., as illustrated by arrow 101 If the truck bed does not already have corresponding openings 124 for the pins 122 (e.g., this is a first time installation in the truck bed 10), then positions of the pins 122 may be marked on the floor 14 of the truck bed 10, and holes drilled at those positions.

With reference again to FIG. 2, the frame 114 may then be secured to the side walls 12a-b of the truck bed 10. For example, the frame 114 may be secured by bolts or other fasteners through holes 116 formed in the frame 114 and aligned with corresponding openings formed in the sidewalls 12a-b of the truck bed 10.

If not already provided, the openings in the sidewalls 12a-b of the truck bed 10 may be formed with an appropriate drill bit by first aligning the frame 114 on top of the sidewalls 12a-b, marking the desired location, and drilling holes. Although not shown, the frame 114 may also be secured to end panel 120.

To disassemble the storage system, the process for assembly can be reversed. Disassembly may easily be performed by a single person. While unassembled, the system components are capable of lying on top of one another to occupy a space small relative to the space defined by the assembled system. This feature facilitates storage and transport of the system.

In an example, handles 105a-b may be provided on the end plate 120 (as shown in FIGS. 1 and 3-4) and/or on the lid assembly 110 (not shown). Handles 105a-b may facilitate the user lifting the end plate 120 into and out of the truck bed 10. Other accessories may also be provided (e.g., locks, hooks, mounts for a sports rack, etc.).

Before continuing, it should be oted that the examples described above are provided for purposes of illustration, and are not intended to be limiting. Other devices andior device configurations may be utilized to carry out the operations described herein.

FIG. 5 is a perspective view of another example assembled truck bed storage system 200, as the lid assembly 210 may be in a closed position. FIG. 6 illustrates the example assembled truck bed storage system 200 shown in FIG. 5, as the lid assembly 210 may be in an open position. The example truck bed storage system 200 is shown in FIGS. 5 and 6 as it may be mounted in a truck bed 10 having sidewalls 12a-b and floor 14.

The lid assembly 210 may include top portion 212 and a frame 214. The top portion 212 may be hinged to the frame 214. The example truck bed storage system 200 also includes an end panel 220, a floor plate 230 and side panels 240a-b (one for each side as shown in FIG. 8, although only one side plate 240a is visible in FIG. 6).

FIG. 7 illustrates a floor plate 230 of the truck bed storage system 200 shown in FIG. 5. In this example, the floor plate 230 includes rails 231 and 232 for receiving a lower edge of the side panels 240a-b, and a rail 233 for receiving the end panel 220. In an example, the floor plate 230 may be secured to the floor 14 of the truck bed 10, e.g., by pins, bolts, or other fasteners so that the floor plate 230 remains in a substantially fixed position in the truck bed 10. In another example, the floor plate 230 need not be secured to the floor 14 of the truck bed 10, as securing the frame 214 to the side walls of the truck bed will aid in securing the truck bed storage system 200.

FIG. 8 illustrates installation of the example the truck bed storage system 200 shown in FIG. 5, in the truck bed 10. In an example, the floor plate 230 is positioned on the truck bed floor 14. Then the end panel 220 and side panels 240a-b are slid into the rails 231-233 (see FIG. 7), e.g., in the direction illustrated by arrows 201 in FIG. 8.

The frame 214 may then be secured to the side walls 12a-b of the truck bed 10. For example, the frame 214 may be secured by bolts or other fasteners through holes formed in the frame 214 and aligned with corresponding openings formed in the sidewalls 12a-b of the truck bed 10, as already described above with reference to FIG. 2. The frame 114 may also be secured to end panel 220, for example, by inserting a bolt or other fastener (only fasteners 250a-b are shown in FIG. 9 through openings 251a-c and 252a-c, as seen in FIGS. 8 and 9.

To disassemble the storage system the process for assembly can be reversed. Disassembly may easily be performed by a single person. While unassembled, the system components are capable of lying on top of one another to occupy a space small relative to the space defined by the assembled system. This feature facilitates storage and transport of the system.

In an example, handles 205a-b may be provided on the end panel 220 (as shown in FIGS. 8 and 9) and/or on the lid assembly 210 (not shown). Handles 205a-b may facilitate the user lifting the end panel 220 into and out of the truck bed 10. Other accessories may also be provided (e.g., locks, hooks, mounts for a sports rack, etc.). For example, latching mechanism including latch 260a-b and turnkey 262a-b and a lock 265 are illustrated in FIGS. 5, 8 and 9.

FIG. 10 is a perspective view of another example assembled truck bed storage system 300, as the lid assembly 310 may be in a closed position. FIG. 11 illustrates the example assembled truck bed storage system 300 shown in FIG. 10, as the lid assembly 310 may be in an open position. The example truck bed storage system 300 is shown in FIGS. 10 and 11 as it may be mounted in a truck bed 10 having sidewalls 12a-b and floor 14.

It is noted that although shown including a floor plate 330, in another example the floor plate 330 may be omitted. Instead, the user may use an end plate with pins, such as the end plate 120 illustrated in FIG. 3 having pins 122. In an example, multiple sets of holes may be provided in the truck bed 10 to enable the end plate 320 to be provided in multiple positions in the truck bed 10.

The lid assembly 310 may include top portion 312 and a substantially “square-U” shaped frame 314. The top portion 312 may include two sections, 312a-b, hingedly connected to one another. The top portion 312 may be hinged to the frame 314. In an example, the frame 314 may be connected to the truck bed 10 using clamps or other attachment mechanism. Although not shown in this example, side panels may also be provided, as described above with reference to FIGS. 5 and 6.

The example truck bed storage system 300 includes one or more separate end panel 320, and a floor plate 330. It is noted that providing separate end panels (e.g., two or more), enables the truck bed storage system 300 to have separate compartments formed therein. Alternatively, a single end panel 320 may be positioned in either of the rails (e.g., rails 331 and 332 shown in FIG. 12) to enable different sizes of the truck bed storage system 300.

FIG. 12 illustrates a floor plate 330 of the truck bed storage system 300 shown in FIGS. 10 and 11. In this example, the floor plate 330 includes rails 331 and 332 for receiving a lower edge of the end panel(s) 320. In an example, the floor plate 330 may be secured to the floor 14 of the truck bed 10, e.g., by pins, bolts, or other fasteners so that the floor plate 330 remains in a substantially fixed position in the truck bed 10. In another example, the floor plate 330 need not be secured to the floor 14 of the truck bed 10, as securing the frame 314 to the side walls of the truck bed will aid in securing the truck bed storage system 300.

FIG. 13 illustrates installation of the example the truck bed storage system 300 shown in FIG. 10, in the truck bed 10. In an example, the floor plate 330 is positioned on the truck bed floor 14. Then the end panel(s) 320 and are slid into the rails 331-332. Top rails 333 and 334 may also be provided in the lid portions 312a-b to secure the end panel(s) 320. Additional slide locks or latches 336a-b and/or other fasteners may also be provided to secure the end panel 320 to the truck bed.

The frame 314 may then be secured to the side walls 12a-b of the truck bed 10. For example, the frame 314 may be secured by bolts, clamps, or other fasteners through holes formed in the frame 314 and aligned with corresponding openings formed in the sidewalls 12a-b of the truck bed 10, as already described above with reference to FIG. 2.

To disassemble the storage system, the process for assembly can be reversed. Disassembly may easily be performed by a single person. While unassembled, the system components are capable of lying on top of one another to occupy a space small relative to the space defined by the assembled system. This feature facilitates storage and transport of the system.

Although not shown on truck bed storage system 300, handles may be provided on the end panel and/or on the lid assembly to facilitate the user configuring, installing and removing the truck bed storage system 300 in the truck bed 10. Other accessories may also be provided (e.g., locks, hooks, mounts for a sports rack, etc.). For example, latch 360a-b are illustrated in FIG. 13 to secure the end plate in an upright position.

The truck bed storage system 300 is configurable and reconfigurable, e.g., for different purposes. In an example, a smaller box and/or toolbox may be provided by installing the mounting bracket and end plate into the position closest to the cab of the truck. The lid is folded in half and this forms the smaller box. The folded lid can be fastened down for traveling. The lid folds down to cover the entire box. To access the box, the lid folds in half, the two sides of the lid lift and stand upright against the cab of the truck. When both lids are upright, these can be locked or fastened into position. To switch from the smaller box to a larger box, the mounting bracket and end plate move, and the lid unfolds. In an example, transformation time is less than 2 minutes.

The storage system may be provided in any of a variety of sizes according to the size of the storage space desired and the size of the pick-up truck bed into which the system will be assembled.

Any of a variety of articles may be held within an assembled truck-bed storage system, for example, tools and camping equipment.

FIG. 14 illustrates an example truck bed storage system 400, as it may be configured to haul an oversize load. In this illustration, the lid assembly 410 has been folded up to enable placement of large boxes 420a-b in the truck bed 10. In an example, a larger box and/or cargo box may be provided by removing the intermediate end plate and installing only an end plate into the position furthest from the cab, or removing the end plate altogether for longer loads, as shown in FIG. 14.

FIG. 15 illustrates an example truck bed storage system 500, as it may be configured to haul a load on top of the lid. In this illustration, anchors 510 are provided on top of the lid assembly to provide an anchor location for connecting straps 520 to secure a suitcase 501.

Still further examples are contemplated. The following example configurations are provided for purposes of illustration, and are not intended to be limiting in any manner.

In an example, a truck owner wishing to store items in a secure manner in a truck bed may decide to use the truck bed storage system (e.g., 100, 200, 300, or variations thereof). The system includes an upright plate, wherein the plate is in the shape of a rectangle, the plate being fitted with at least two pins spaced apart on a long edge of the plate. Further the system includes a rectangular top plate that has a frame and a lid portion which are connected via a hinge or other appropriate means. The top plate frame may have pre-drilled holes, e.g., one in each short side of the rectangular frame portion.

To construct the storage system holes are drilled in the bed of the truck so as to substantially match the placement of the pins of the upright plate. Once the upright place is secured, which may be attained by use of the pins solely or an additional system wherein the top portion of the upright plate is fitted to the truck bed for example with pins that slide from the upright plate into the sides of the truck bed. Next, the lid plate may be affixed to the rails of the bed in a temporary manner.

To affix the lid plate to the truck, holes in the frame are marked on the bed rails, and holes are drilled of the appropriate size. Bolts may be guided through the top plate pre-drilled holes and the holes drilled in the bed railing(s) and secured with a nut. Once the upnght plates and top plates are fixed to the truck bed an inner space is formed by the cab wall, two side rails or walls of the truck bed, the upright and lid plates of the storage system. The lid plate may be locked to the upright plate using for instance a padlock.

In another example, the dimension of the inner space may cover about a third of the truck bed (e.g., as is shown in FIG. 1), about two-thirds of the bed (e.g., as shown in FIG. 5), or a lid that has two panels may be employed (e.g., as shown in FIG. 10). It is noted that the example shown in FIG. 10 may include two sections that are substantially the same size, or the two sections may be different sizes. This arrangement enables a user to store items inside the storage system in front of the storage system area but under the lid, and on top of the storage system area for stowage of larger items, e.g., such as for bicycles.

It is noted that the examples shown and described are provided for purposes of illustration and are not intended to be limiting. Still other examples are also contemplated.

1. A modular truck bed storage system, comprising:
a removable end panel, and
a lid assembly having a top portion connected to a frame to operate between an open position and a closed position, wherein the frame is configured for securement to at least one sidewall of a truck bed.

2. The system of claim 1, further comprising a floor plate.

3. The system of claim 2, wherein the floor plate includes at least one rail for receiving the removable end panel.

4. The system of claim 2, further comprising side panels.

5. The system of claim 4, wherein the floor plate includes respective rails for receiving the side panels.

6. The system of claim 1, further comprising two end panels.

7. The system of claim 1, wherein the lid assembly includes at least two sections, one of the two sections foldable over another of the two sections to partially open a compartment formed in the truck bed under the lid assembly.

8. The system claim 1, wherein the frame is substantially box shaped.

9. The system of claim 1, wherein the frame is substantially square-U shaped.

10. The system of claim 1, wherein the removable end panel includes pins for securement to a floor of the truck bed.

11. A method for providing a modular storage compartment in a truck bed, comprising:
providing at least one removable end panel; and
providing a lid assembly having a top portion connected to a frame, the top portion configurable between an open position and a closed position; and
securing the frame to at least one sidewall of the truck bed.

12. The method of claim 11, further comprising providing a floor plate, wherein the floor plate includes at least one rail for receiving the removable end panel.

13. The method of claim 11, further comprising providing side panels in respective rails of a floor plate.

14. The method of claim 11, wherein the lid assembly includes at least two sections, one of the two sections foldable over another of the two sections to partially open a compartment formed in the truck bed under the lid assembly.

15. A system for providing a storage compartment in a truck bed, comprising:
means for forming a compartment in a truck bed with at least one removable panel; and
means for securing the at least one removable panel in the truck bed; and
means for covering and uncovering the compartment.

16. The system of claim 15, further comprising means for overlaying at least a portion of a floor of the truck bed.

17. The system of claim 16, further comprising means for receiving the at least one removable panel in the means for overlaying.

18. The system of claim 16, further comprising means for protecting at least a portion of the side walls of the truck bed.

19. The system of claim 18, further comprising means for protecting in the means for overlaying.

20. The system of claim 15, wherein the means for covering has at least two sections to form sub-compartments within the compartment.
